(19) United States
(12) Patent Application Publication
(10) Pub. No.: US 2022/0146342 A1
(43) Pub. Date: May 12, 2022

(54) SENSOR

(71) Applicant: Oxford University Innovation Limited, Oxford (GB)

(72) Inventors: Wing Chung LIU, Oxford (Oxfordshire) (GB); Andrew WATT, Oxford (Oxfordshire) (GB)

(21) Appl. No.: 17/431,842

(22) PCT Filed: Feb. 24, 2020
(86) PCT No.: PCT/GB2020/050430

§ 371 Date: Aug. 18, 2021

(30) Foreign Application Priority Data
Feb. 25, 2019 (GB) 1902515.4

(51) Int. Cl. G01L 1/22; C08J 5/04; C08J 5/18; G01L 1/14; B32B 27/08; B32B 27/20; B32B 27/30

(52) U.S. Cl. CPC G01L 1/2287; C08J 5/041; C08J 5/18; G01L 1/146; C08K 2003/0806; B32B 27/20; B32B 27/306; C08J 2323/08; B32B 27/08

(57) ABSTRACT

The invention relates to a force sensor which comprises a sensor material which comprises a plurality of metal nanowires dispersed within a matrix; and a measurement device configured to measure an electrical property of the sensor material, wherein the electrical property is one which changes in response to the application of a force to the sensor material.

### FIELD OF THE INVENTION

The invention provides a force sensor comprising a sensor material and a measurement device. The invention also provides a force sensor comprising an array of sensor materials and at least one measurement device. The invention also provides a method for sensing force.

### BACKGROUND TO THE INVENTION

This invention relates to the field of force sensing materials and force sensors, for instance devices for sensing pressure or strain. Such devices typically work by converting a force applied to the device into an electrical signal which can be detected. Traditionally, pressure sensors can generally be categorised as capacitive, piezoelectric or piezoresistive sensors.

Firstly, capacitive pressure sensors typically consist of two conductive sheets of materials separated by a dielectric material (a parallel plate capactitor). When a pressure is applied, the distance between the conductive materials decreases and the resultant capacitance of the system changes and is detected. Examples of such pressure sensors may be found in U.S. Pat. No. 6,492,979 and in Thomas V. Papakostas et al., A large area force sensor for smart skin applications, Sensors, 2002, IEEE.

Next, piezoelectric pressure sensors rely on the piezoelectric properties of certain ceramic materials like Lead Zirconate Titanate (PZT). A potential difference is generated across the piezoelectric material when an external pressure is applied on it. However, lead-containing materials such as PZT have high toxicities.

Lastly, piezoresistive pressure sensors make use of materials like silicon which undergo a change in electrical resistivity when a pressure is applied.

The main drawback of traditional pressure sensor materials is their lack of flexibility. For instance, ceramic materials cannot easily be fabricated as flexible components. In recent years, there has been an increase in demand for flexible force sensing devices as they can be applied to curved and movable surfaces. Flexible pressure sensors have also found applications in health monitoring, motion sensing and artificial skin for robotics.

Strain gauges are sensors in which, typically, the electrical resistance varies in response to an applied force. Conventional strain gauges comprise a conducting pattern that flexes leading to a measurable change in resistance. When the strain gauge is mounted on a object, deformation of the object results in distortion of the strain gauge and the strain in the object may be calculated from the change in resistance. Such strain gauges are generally more sensitive to strain in one direction, may have limited dynamic ranges and be unable to work in applications involving large strains.

There therefore exists a need for flexible force sensors made from non-toxic materials. Such a force sensor must also be energy efficient to run, have improved sensitivity, large dynamic ranges and be able to withstand large forces.

### SUMMARY OF THE INVENTION

The invention provides a force sensor which addresses the issues noted above. In particular, a force sensor is provided that comprises a sensor material comprising a conductive nanowire network embedded within a matrix material. The resistance of the sensor material changes based on how the applied force alters the percolation properties of the nanowire network within the matrix material. The sensor material exhibits piezoresistive and capacitative properties that makes it suitable to be used as a force sensor. The sensor material is flexible, and can be manufactured as thin films allowing it to be attached to a wide variety of surfaces. For instance, the material can be readily attached to or deposited on a substrate to provide a ready made strain gauge.

The sensing properties of the sensor material, like dynamic range and sensitivity are also tunable by changing the structure of the material. For instance, altering the density of nanowires changes the number of nanowire-nanowire contacts thereby impacting sensitivity. Increasing the quantity of matrix material increases the dynamic range, as a greater force is required to produce the same stress within the sensor material.

Also, the sensor material has low resistance, therefore has a low power consumption and can be used with low voltage power sources. This makes the force sensor incorporating the sensor material more efficient and less costly to run.

Accordingly, the present invention provides a force sensor comprising a sensor material which comprises a plurality of metal nanowires dispersed within a matrix; and a measurement device configured to measure an electrical property of the sensor material, wherein the electrical property is one which changes in response to the application of a force to the sensor material. For instance, the electrical property may be one which changes in response to an internal stress in the sensor caused by application of a force to the sensor material.

The present invention also provides a force sensor which comprises an array of sensor materials, wherein each sensor material comprises a plurality of metal nanowires dispersed within a matrix; and at least one measurement device, wherein the at least one measurement device is configured to measure an electrical property of each sensor material, wherein the electrical property is one which changes in response to the application of a force to the sensor material. The electrical property may be one which changes in response to an internal stress in the sensor material caused by application of a force to the sensor material.

The present invention also provides a method of sensing force applied to a sensor material, comprising applying a force to a sensor material, wherein the sensor material comprises a plurality of metal nanowires dispersed within a matrix; and measuring an electrical property of the sensor material. The electrical property is one which changes in response to the application of the force to the sensor material. For instance it may change in response to an internal stress in the sensor material caused by application of the force to the sensor material.

The present invention also provides a film of an material comprising a plurality of metal nanowires dispersed within a matrix material, wherein the distribution of the metal nanowires throughout the thickness of the film is non-uniform.

The present invention also provides a material comprising a plurality of metal nanowires dispersed within a matrix material, wherein the matrix material comprises a copolymer of ethylene and vinyl acetate (ethylene-co-vinyl acetate).

### BRIEF DESCRIPTION OF THE FIGURES

FIG. 1 is a schematic of part of a force sensor of the present invention, showing a film of the sensor material and electrical connectors (e.g. copper tape) connected to opposite sides of the film.

FIG. 2A is a schematic showing pressure or compressive force being applied to a film of a sensor material placed on a substrate. The dark layer in the sensor material indicates a layer of higher metal nanowire density. FIG. 2B shows how the resistance of the sensor material changes in response to the pressure applied. As pressure is increased, i.e. as the sensor material is compressed, the resistance of the sensor material decreases.

FIG. 3A is a schematic showing pressure being applied to a film of a sensor material placed on a support such that the edges of the film are supported and the middle of the film is free to move. The dark layer in the sensor material indicates a layer of higher metal nanowire density. FIG. 3B shows how the resistance of the sensor material changes in response to the pressure applied. As the force applied to the middle of the film is increased, i.e. as the sensor material is stretched (placed under tension), the resistance of the sensor material increases.

FIG. 4A is a schematic showing pressure being applied to a film of a sensor material placed on a substrate. The dark layers in the sensor material indicates layers of higher metal nanowire density. FIG. 4B shows how the capacitance of the sensor material changes in response to the pressure applied. As pressure is increased, i.e. as the sensor material is compressed, the capacitance of the sensor material increases.

FIG. 5 shows an SEM image of a film of Ag nanowires in a poly(ethylene-co-vinyl acetate) matrix, made in accordance with Example 1 below.

FIG. 6 is a photograph of a film of Ag nanowires in a poly(ethylene-co-vinyl acetate) matrix, made in accordance with Example 1 below.

FIG. 7 shows the general structure of a typical strain gauge.

FIG. 8 is a SEM image of Ag nanowire-EVA composite film, showing the morphology of the film on the high nanowire density side. The spaces between the nanowires are filled by EVA.

### DETAILED DESCRIPTION OF THE INVENTION

### Definitions

The term “metal nanowire” refers to a metallic wire comprising one or more of elemental metal, metal alloys or metal compounds (such as metal oxides). For the avoidance of doubt, the term “metal nanowire” includes hollow wires and those which are not hollow.

The term “alkyl”, as used herein, refers to a linear or branched chain saturated hydrocarbon radical. An alkyl group may be a C₁₋₂₀ alkyl group, a C₁₋₁₄ alkyl group, a C₁₋₁₀ alkyl group, a C₁₋₆ alkyl group or a C₁₋₄ alkyl group. Examples of a C₁₋₁₀ alkyl group are methyl, ethyl, propyl, butyl, pentyl, hexyl, heptyl, octyl, nonyl or decyl. Examples of C₁₋₆ alkyl groups are methyl, ethyl, propyl, butyl, pentyl or hexyl. Examples of C₁₋₄ alkyl groups are methyl, ethyl, i-propyl, n-propyl, t-butyl, s-butyl or n-butyl. If the term “alkyl” is used without a prefix specifying the number of carbons anywhere herein, it has from 1 to 6 carbons (and this also applies to any other organic group referred to herein).

The term “alkenyl”, as used herein, refers to a linear or branched chain hydrocarbon radical comprising one or more double bonds. An alkenyl group may be a C₂₋₂₀ alkenyl group, a C₂₋₁₄ alkenyl group, a C₂₋₁₀ alkenyl group, a C₂₋₆ alkenyl group or a C₂₋₄ alkenyl group. Examples of a C₂₋₁₀ alkenyl group are ethenyl (vinyl), propenyl, butenyl, pentenyl, hexenyl, heptenyl, octenyl, nonenyl or decenyl. Examples of C₂₋₆ alkenyl groups are ethenyl, propenyl, butenyl, pentenyl or hexenyl. Examples of C₂₋₄ alkenyl groups are ethenyl, i-propenyl, n-propenyl, s-butenyl or n-butenyl. Alkenyl groups typically comprise one or two double bonds.

The term “aryl”, as used herein, refers to a monocyclic, bicyclic or polycyclic aromatic ring which contains from 6 to 14 carbon atoms, typically from 6 to 10 carbon atoms, in the ring portion. Examples include phenyl, naphthyl, indenyl, indanyl, anthrecenyl and pyrenyl groups. The term “aryl group”, as used herein, includes heteroaryl groups.

The term “heteroaryl”, as used herein, refers to monocyclic or bicyclic heteroaromatic rings which typically contains from six to ten atoms in the ring portion including one or more heteroatoms. A heteroaryl group is generally a 5- or 6-membered ring, containing at least one heteroatom selected from O, S, N, P, Se and Si. It may contain, for example, one, two or three heteroatoms. Examples of heteroaryl groups include pyridyl, pyrazinyl, pyrimidinyl, pyridazinyl, furanyl, thienyl, pyrazolidinyl, pyrrolyl, oxazolyl, oxadiazolyl, isoxazolyl, thiadiazolyl, thiazolyl, isothiazolyl, imidazolyl, pyrazolyl, quinolyl and isoquinolyl.

The terms “disposing on” or “disposed on”, as used herein, refers to the making available or placing of one component on another component. The first component may be made available or placed directly on the second component, or there may be a third component which intervenes between the first and second component. For instance, if a first layer is disposed on a second layer, this includes the case where there is an intervening third layer between the first and second layers. Typically, “disposing on” refers to the direct placement of one component on another.

The term “layer”, as used herein, refers to any structure which is substantially laminar in form (for instance extending substantially in two perpendicular directions, but limited in its extension in the third perpendicular direction). A layer may have a thickness which varies over the extent of the layer. Typically, a layer has approximately constant thickness. The “thickness” of a layer, as used herein, refers to the average thickness of a layer. The thickness of layers may easily be measured, for instance by using microscopy, such as electron microscopy of a cross section of a film, or by surface profilometry for instance using a stylus profilometer.

### Force Sensor

The present invention provides a force sensor which comprises a sensor material which comprises a plurality of metal nanowires dispersed within a matrix; and a measurement device configured to measure an electrical property of the sensor material, wherein the electrical property is one which changes in response to application of a force to the sensor material. For instance, the electrical property may be one which changes in response to an internal stress in the sensor caused by application of a force to the sensor material.

Typically, the sensor material as a whole (matrix and metal nanowires) is electrically conductive although the matrix itself is typically an insulator. Those skilled in the art will understand the meaning of the term “electrically-conductive”. The sheet resistance of the sensor material (particularly if the sensor material is in the form of a film) may optionally be no more than 100 Ω/square, optionally no more than 500 Ω/square, optionally no more than 250 Ω/square, optionally no more than 1000 Ω/square, optionally no more than 50 Ω/square, optionally at least 1 Ω/square, optionally from 1 to 1000 Ω/square, optionally from 1 to 75 Ω/square and optionally from 3 to 50 Ω/square. A change (increase or decrease) in the above electrical conductivity which occurs upon application of a force to the sensor material may be measured in the method of the invention.

Typically, the sensor material has a low electrical resistance. For instance, the resistance of the sensor material may be no more than 100Ω, no more than 50Ω, no more than 25Ω or no more than 20Ω. Typically the resistance of the sensor material is from 0.1 to 100Ω, from 0.5 to 50Ω or from 1 to 20Ω. A change (increase or decrease) in the above resistance which occurs upon application of a force to the sensor material may be measured in the method of the invention.

Typically, the sensor material is resilient. Thus, typically, the sensor material deforms on application of the force and return to its original shape upon removal of the force. Thus, typically, the sensor material does not undergo a permanent deformation in response to the force.

The electrical property may be resistance, resistivity, conductance, conductivity, capacitance, inductance, admittance, transconductance, transimpedance, reactance, or susceptance. Typically, the electrical property is resistance, conductance, resistivity, conductivity, or capacitance. More typically, the electrical property is resistance, conductance, or capacitance. As the skilled person will appreciate resistance is the reciprocal of conductance; hereinafter the term conductance may be used instead wherever the word resistance is mentioned, i.e. conductance could be measured instead of resistance. A change in any of the above electrical properties which occurs upon application of a force to the sensor material may be measured in accordance with the method of the invention.

Typically the electrical property is resistance or capacitance. Thus, the force sensor may comprise a measurement device configured to measure the resistance of the sensor material, wherein the resistance of the sensor material changes in response to (an internal stress in the sensor material caused by) application of a force to the sensor material. The force sensor may comprise a measurement device configured to measure the capacitance of the sensor material, wherein the capacitance of the sensor material changes in response to (an internal stress in the sensor material caused by) application of a force to the sensor material. In one embodiment, the force sensor may comprise a measurement device configured to measure the resistance and the capacitance of the sensor material, wherein both the resistance and the capacitance of the sensor material change in response to (an internal stress in the sensor material caused by) application of a force to the sensor material.

The force may be any force suitable to induce an internal stress within the sensor material. The internal stress causes the conductive nanowires within the matrix to move relative to one another (e.g. move closer together, or further apart, and thereby increase or decrease the number of nanowire-nanowire contacts) to alter the percolation properties of the nanowire network within the matrix, and thereby alter the electrical properties of the sensor material. In one embodiment, the force may be a pressure or compressive force that causes compression of the sensor material and internal compressive stress. The compressive force or pressure alters the number of contacts between the nanowires, thereby altering the electrical properties of the material. In this way, the force sensor detects when a compressive force or pressure is applied to the sensor material by the change in electrical properties of the sensor material. Thus the force sensor may be a pressure sensor, and the present invention also relates to a pressure sensor comprising a sensor material as described herein; and a measurement device configured to measure an electrical property of the sensor material, wherein the electrical property is one which changes in response to the application of pressure to the sensor material. The electrical property may be one which changes in response to internal stress in the sensor material caused by application of said pressure.

Therefore in one embodiment, the electrical property is resistance and the force is a compressive force or pressure. Typically, in this embodiment, the compressive force or pressure pushes the metal nanowires in the sensor material closer together, increasing the number of nanowire-nanowire contacts, thereby lowering the resistance of the sensor material.

In another embodiment, the electrical property is capacitance and the force is a compressive force or pressure. Typically, in this embodiment, separate regions of higher nanowire density in the sensor material are forced closer together under the compressive force or pressure, the capacitance increases.

In another embodiment, the force is a tensile force applied to the sensor material. Tensile force will stretch the sensor material leading to internal tensile stress. The tensile force may be the result of, for example, pulling opposing portions of the sensor material apart. The tensile force may be the result of bending the sensor material, for instance by applying a force or pressure to part of the sensor material that causes the sensor material to bend. The tensile force may be the result of bending the sensor material, for instance in the situation where the sensor material is mounted on a substrate and the substrate bends in response to a force. As the substrate changes shape upon application of a force, the sensor material mounted on the substrate experiences a tensile force which effects the electrical properties, typically the resistance, of the sensor material.

In one embodiment, the electrical property is resistance and the internal stress in the sensor material is tensile stress caused by application of the force to the sensor material. Typically, in this embodiment, the sensor material stretches under application of a tensile force and the nanowires in the sensor material are pulled apart, reducing the number of nanowire-nanowire contacts, thereby increasing the resistance of the sensor material.

The force sensor may be mounted upon a substrate and used to detect strain in the substrate. Thus, the force sensor may be a strain gauge. Therefore, the present invention also relates to a strain gauge comprising a sensor material as described herein; and a measurement device configured to measure an electrical property of the sensor material, wherein the electrical property is one which changes in response to the application of a tensile force to the sensor material. The electrical property may be one which changes in response to an internal stress in the sensor material caused by application of a tensile force to the sensor material.

Typically, the sensor material is not transparent. For instance, the sensor material may be opaque, or translucent. Typically, the sensor material is opaque.

Typically, the sensor material is in the form of a film. The mean thickness of the film of the sensor material may be at least 10 nm, at least 50 nm, at least 500 nm, at least 1 μm, at least 10 μm, at least 100 μm, at least 1 mm, or at least 2 mm. Typically, the thickness of the film is no more than 10 mm, no more than 9 mm, no more than 8 mm, no more than 7 mm, no more than 6 mm, no more than 5 mm, no more than 4 mm, no more than 3 mm, no more than 2 mm or no more than 1 mm. Hence, the thickness of the film of the sensor material may be between 1 μm and 10 mm, between 1 μm and 5 mm, between 1 μm and 1 mm, for instance between 1 μm and 500 μm, or for instance from 1 μm to 100 μm, for example from 2 μm to 50 μm or from 5 μm to 20 μm.

The distribution of the metal nanowires through the film of the sensor material may be uniform or non-uniform. Typically, the distribution of the metal nanowires throughout the thickness of the film is non-uniform. Thus, the film may comprise one or more regions of higher nanowire density and one or more regions of lower nanowire density. The density typically changes along the thickness (height) of the film, as opposed to along its length or breadth.

Thus, the film of the sensor material may comprise a first sub-layer in contact with a second sub-layer, wherein both the first sub-layer and the second sub-layer comprise a plurality of the metal nanowires dispersed within the matrix, wherein the density of the metal nanowires is greater in the first sub-layer than in the second sub-layer.

Typically, the density of the metal nanowires in the first sub-layer is more than twice the density of metal nanowires in the second sub-layer. For instance, the density of the metal nanowires in the first sub-layer may be more than three times, more than four times or more than five times the density of metal nanowires in the second sub-layer. Thus, the second sub-layer may primarily comprise the matrix material.

The density of the nanowires in the first sub-layer may be from 50-1000% of the density of the nanowires in the second sub-layer. For instance, the density of the nanowires in the first sub-layer may be from 100-1000% of the density of the nanowires in the second sub-layer, or from 150 to 500% of the density of the nanowires in the second sub-layer.

The density of nanowires may change continuously through the cross-section of the film of the sensor material. Alternatively, the density of nanowires may be non-continuous, i.e. the film may comprise a lower density region in direct contact with a higher density region, with no region of intermediate nanowire density in between.

The first sub-layer and the second sub-layer may have approximately the same thickness. Alternatively, the first sub-layer and the second sub-layer may have different thicknesses. For instance, the first sub-layer may have a greater thickness than the second sub-layer, or the second sub-layer may have a greater thickness than the first sub-layer.

Generally, the first sub-layer is 0.1 to 50% of the thickness of the film of the sensor material and the second sub-layer is from 50 to 99.9% of the thickness of the film of the sensor material. For instance, the first sub-layer may be 0.1 to 25% of the thickness of the film and the second sub-layer is from 75 to 99.9% of the thickness of the film. Typically, the first sub-layer is 0.5 to 5% of the thickness of the film and the second sub-layer is from 95 to 99.5% of the thickness of the film.

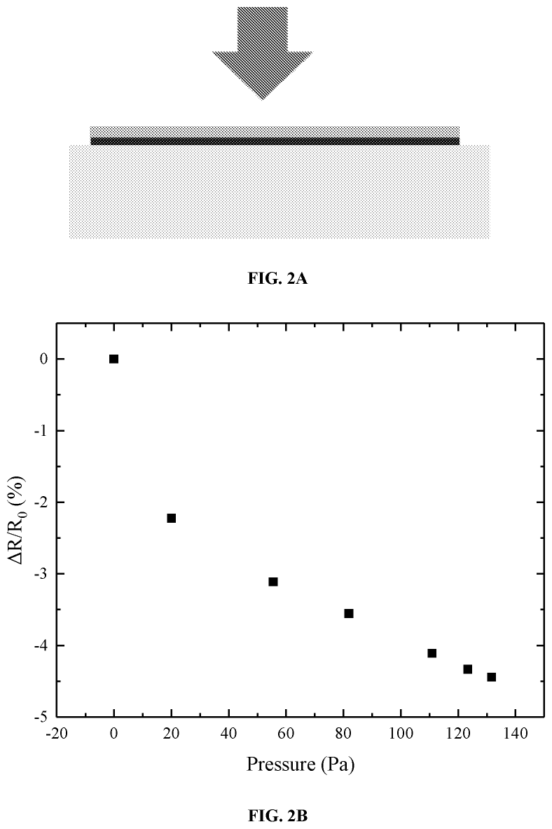

In one embodiment, the sensor material comprises a first sub-layer in contact with a second sub-layer as described herein, and the electrical property is resistance. In one embodiment, the sensor material comprises a first sub-layer in contact with a second sub-layer as described herein, and the force applied to the sensor material is a compressive force that pushes the nanowires closer together, and the electrical property measured is resistance. FIG. 2A is a schematic showing a compressive force or pressure being applied to a film of a sensor material having first and second sub-layers as described herein. FIG. 2B shows how the resistance of the sensor material changes in response to the force applied.

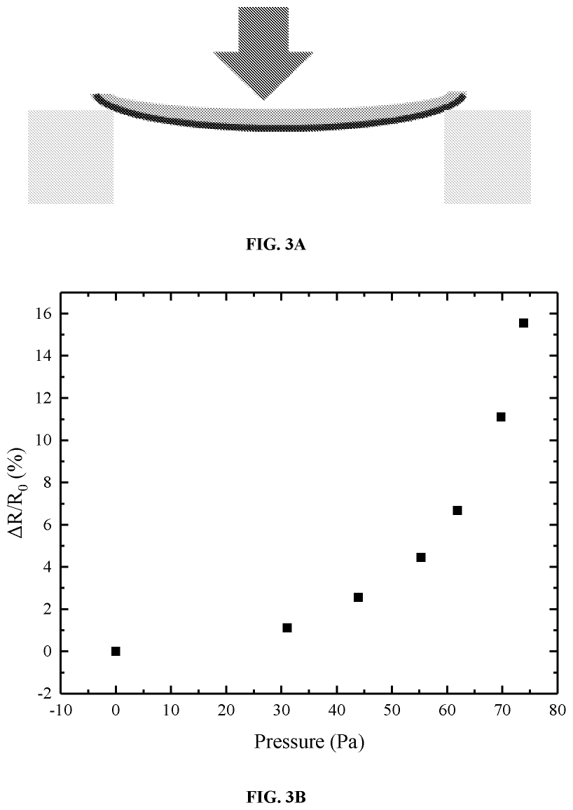

In one embodiment, the sensor material comprises a first sub-layer in contact with a second sub-layer as described herein, wherein the force applied to the sensor material is a force that causes a tensile stress within the sensor material that pulls the nanowires apart, and the electrical property measured is resistance. FIG. 3A is a schematic showing a tensile force being applied to a film of a sensor material having first and second sub-layers as described herein. FIG. 3B shows how the resistance of the sensor material changes in response to the force applied.

The film of the sensor material may comprise a third sub-layer in contact with the second sub-layer, such that the second sub-layer is disposed between the first and third sub-layers. Typically, the density of the metal nanowires is greater in the third sub-layer than in the second sub-layer. Hence, the film of the sensor material may comprise a first sub-layer in contact with a second sub-layer, and a third sub-layer in contact with the second sub-layer. The second sub-layer may form a region of lower nanowire density between the first and third sub-layers. In this embodiment, the first and third-sub layers are more conductive than the second sub-layer, due to the higher density of metal nanowires. When the more highly conducting first and third sub-layers are brought into closer proximity, for instance by application of a force, for example a pressure or compressive force to the film of the sensor material, the capacitance of the film of the sensor material changes. Thus, the film of the sensor material may comprise a third sub-layer (as described herein) in contact with the second sub layer, such that the second sub-layer is disposed between the first and third sub-layers and the electrical property is capacitance. Typically, the force applied to the sensor material is a pressure or compressive force that pushes the first and third sub-layers closer together, and the electrical property measured is capacitance.

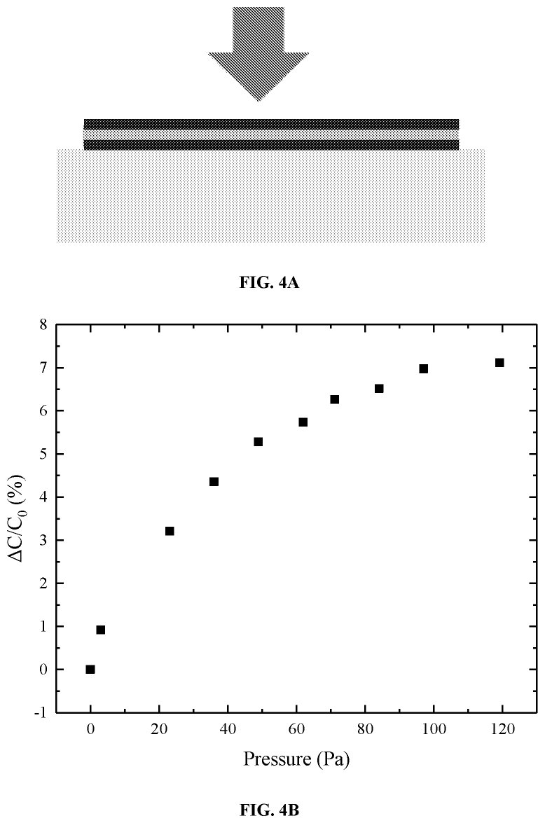

FIG. 4A is a schematic showing a compressive force or pressure being applied to a film of a sensor material having first, second and third sub-layers as described herein. FIG. 4B shows how the capacitance of the sensor material changes in response to the force applied.

The density of the metal nanowires in the third sub-layer may be more than twice the density of metal nanowires in the second sub-layer. For instance, the density of the metal nanowires in the third sub-layer may be more than three times, more than four times or more than five times the density of metal nanowires in the second sub-layer. Thus, the second sub-layer may primarily comprise the matrix material. Typically, the density of the metal nanowires in the first and third sub-layers is the same.

The density of the nanowires in the third sub-layer may be from 50-1000% of the density of the nanowires in the second sub-layer. For instance, the density of the nanowires in the third sub-layer may be from 100-1000% of the density of the nanowires in the second sub-layer, or from 150 to 500% of the density of the nanowires in the second sub-layer.

The first sub-layer, the second sub-layer and the third sub-layer may have approximately the same thickness. Alternatively, the first sub-layer, the second sub-layer and the third sub-layer may have different thicknesses. For instance, the first and third sub-layers may each have a greater thickness than the second sub-layer, or the second sub-layer may have a greater thickness than each of the first and third sub-layers. Typically, the second sub-layer has a greater thickness than the first and third sub-layers. For instance, the combined thickness of the first and third sub-layers may be from 0.1 to 50% of the thickness of the film, from 0.1 to 25% the thickness of the film, from 0.1 to 10% of the thickness of the film or from 0.5 to 5% of the thickness of the film.

In one embodiment, the film of the sensor material comprising the first, second and third sub-layers is formed from two films, each comprising a first and second sub-layer as described herein, attached or bonded together. For instance, the film of the sensor material may comprise a first film, comprising a first and second sub-layer as described herein attached to a second film comprising first and second sub-layer as described herein. Typically, in each of the first and second films, both the first sub-layer and the second sub-layer comprise a plurality of the metal nanowires dispersed within the matrix, wherein the density of the metal nanowires is greater in the first sub-layer than in the second sub-layer. The second sub-layers of the first and second films are typically attached to one another to form a film comprising first, second and third sub-layers where the second sub-layer forms a region of lower nanowire density between the first and third sub-layers.

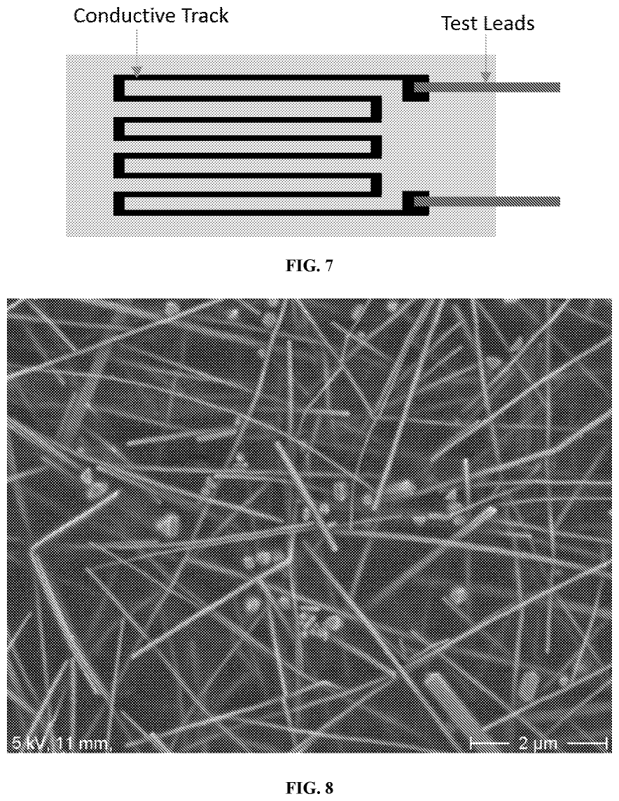

In one embodiment, the force sensor is a strain gauge and the sensor material is or comprises a track of conductive material. The word “track”, as used herein refers to a strip of conductive material that may be arranged into a pattern. For instance, the track may be a strip of a sensor material, as described herein, disposed in a pattern on a substrate. Alternatively sensor material may comprise a track of nanowires embedded into a film of a matrix material, as described herein, in a pattern. A schematic of a typical strain gauge track is shown in FIG. 7. Therefore, typically when the sensor material is or comprises a track in a pattern, a portion of the pattern takes the form of a zig-zag pattern of parallel lines. In this embodiment, the electrical property is typically resistance and the force is typically a force that causes a tensile stress within the sensor material that pulls the nanowires apart. For instance, when the strain gauge of this embodiment is mounted on an object, when the object bends the sensor material will stretch and the number of nanowire-nanowire contacts in the conductive track will decrease. Similarly, if torque is applied to the object, the sensor material will stretch and the number of nanowire-nanowire contacts in the conductive track will decrease.

### Solid Substrate

The force sensor as described herein may further comprise a solid substrate, or may be disposed on a solid substrate.

Typically the force sensor comprises a film of sensor material as described herein disposed on the solid substrate. Thus, typically, one side of the film of sensor material is in contact with the substrate, either directly or via an intermediate layer. The solid substrate may act as a surface against which the film of the sensor material can be compressed, for instance in response to a compressive force or pressure (see FIGS. 2A, 2B, 4A and 4B). Hence, the force sensor as described herein may be a pressure sensor. For instance, the film of the sensor material disposed on the substrate may comprise a first sub-layer and a second sub-layer as described herein, and the electrical property measured may be resistance. Alternatively, the film of the sensor material disposed on the substrate may comprise first, second and third sub-layers as described herein and the electrical property measured may be capacitance.

The solid substrate on which the sensor material is disposed may distort in response to a force, causing the film of the sensor material to experience a tensile stress. Thus, the force sensor of the present invention may be a strain gauge that detects strain in the solid substrate, or in an object on which the solid substrate is mounted. Typically, in this embodiment, the sensor material is in the form of a film comprising a first sub-layer and a second sub-layer as described herein, and the electrical property measured is resistance. The sensor material may also comprise a track as described herein and be mounted upon a substrate.

### Support

The force sensor may comprise a support, wherein the film of sensor material is supported at two or more edges by the support. For instance, the film of sensor material may be supported at all external edges, whilst the central portion of the film is unsupported. Thus, the edges of the film of the sensor material may be attached to the support such that a portion of the film of sensor material is unsupported and is free to distort, for instance to stretch or bend, under application of a force.

In this configuration, typically, the film of the sensor material may comprise a first sub-layer and a second sub-layer as described herein, and the electrical property measured may be resistance. Thus, when the force sensor comprises a support, typically the force applied to the sensor material is a force that causes a tensile stress within the sensor material that pulls the nanowires apart, and the electrical property measured is resistance. FIG. 3A is a schematic showing a tensile force being applied to a film of a sensor material having first and second sub-layers as described herein on a support. FIG. 3B shows how the resistance of the sensor material changes in response to the force applied.

### Electrical Connector

Typically, the force sensor comprises at least one electrical connector which forms an electrical connection between the sensor material and the measurement device. Usually, the force sensor further comprises a first electrical connector and a second electrical connector, wherein the first and second electrical connectors form an electrical connection between the sensor material and the measurement device. Typically, the first and second electrical connectors are connected to two opposing regions of the sensor material. Thus, the measurement device is able to measure an electrical property, for instance current, voltage, resistance or capacitance across a portion of the sensor material.

In one embodiment, the force sensor comprises the sensor material in the form of a film, a first electrical connector and a second electrical connector, wherein the first and second electrical connectors form an electrical connection between the sensor material and the measurement device, wherein the first and second electrical connectors are attached to opposing edges or corners of the film of the sensor material. Typically, in this configuration, the electrical property measured is resistance. For example, the electrical property is resistance and the force is a compressive force, or the electrical property is resistance and the internal stress in the sensor material is tensile stress caused by application of the force to the sensor material.

In one embodiment, the force sensor comprises the sensor material in the form of a film, a first electrical connector and a second electrical connector, wherein the first and second electrical connectors form an electrical connection between the sensor material and the measurement device, wherein the first and second electrical connectors are attached to opposing faces of the film of the sensor material. Typically, in this configuration, the film of the sensor material comprises first, second and third-sub-layers as described herein. Typically, the electrical property measured is capacitance, for example the electrical property is capacitance and the force is a compressive force.

Typically, the first and second electrical connectors, as described herein are metal wires, for example copper wires. The first and second electrical connectors may be connected the sensor material by any means known to the skilled person, for example clips, conductive tape, or the first and second electrical connectors may be inductively coupled to the sensor material.

### Measurement Device

In the force sensor described herein, the measurement device may be any measurement device known by the skilled person suitable for measuring an electrical property. For example, the measurement device may be any device suitable for measuring voltage, current, resistance or capacitance. Examples of such devices include LCR meters (for instance a Agilent E4980A Precision LCR Meter), source meters (for instance a Kiethley 2400 source meter), or electronics based on National Instrument or Arduino platforms. As the skilled person would appreciate, an LCR meter is a type of electronic test equipment used to measure the inductance (L), capacitance (C) and resistance (R) of an electronic component.

### Sensor Material Matrix

The sensor material comprises a plurality of metal nanowires dispersed within a matrix. The matrix may be any material known to the skilled person that is able to stretch or compress under application of a force, for example to compress under application of a compressive force or pressure, and/or to stretch under application of a tensile force. Typically, the matrix material is resilient. Thus, typically, the matrix material deforms on application of the force and return to its original shape upon removal of the force. Thus, typically, the matrix material does not undergo a permanent deformation in response to the force. Typically, the matrix material will recover its original shape after stretching or compression. Thus, typically the matrix material is elastic.

Typically, the matrix material is an insulator. Typically, the resistance of the matrix material is on the scale of giga-ohms, i.e. at least 1,000,000,000Ω.

Typically, the matrix comprises a polymer. The polymer is typically an insulating polymer. Usually, the matrix material comprises an elastic polymer. The matrix may comprise one or more polymers, for instance two or more polymers or there or more polymers. These are typically insulating polymers. Typically, the matrix comprises a single elastic polymer. This single elastic polymer is typically an insulating polymer.

If the matrix comprises one or more polymers, then at least one polymer may have an average molecular weight (Mn) of at least 5000, at least 10,000, at least 20,000, at least 50,000, for example no more than 500,000 or no more than 250,000. At least one polymer in the matrix may optionally have a degree of polymerisation of at least 100, at least 200, at least 500, at least 1000, for instance no more than 10,000 or no more than 5000.

The or each polymer, or at least one of the polymers, typically has a glass transition temperature (T_{g}) of below 0° C., preferably below −10° C., more preferably below −20° C. For instance, the glass transition temperature may be below −30° C. The glass transition temperature of the polymer may be above −80° C., for instance above −70° C., above −60° C., above −50° C. or above −40° C. For instance, the glass transition temperature may be between 0° C. and −80° C., between −10° C. and −70° C., between −20° C. and −60° C. or between −30° C. and −50° C.

Typically, the or each polymer, or at least one of the polymers, results from polymerisation of one or more monomers comprising a vinylidene moiety. For instance, the polymer may be a copolymer of ethylene and vinyl acetate (poly(ethylene-co-vinyl acetate)), polyvinyl alcohol, or polyvinyl acetate.

The or each polymer, or at least one of the polymers, may be a homopolymer or a copolymer. When the polymer is a homopolymer, the polymer may be a homopolymer resulting from polymerisation of a monomer comprising a vinylidene moiety, or a polysiloxane. For instance, the homopolymer may be poly-vinylalcohol, polyvinyl acetate or polydimethylsiloxane (PDMS).

Typically, the or each polymer, or at least one of the polymers, is a copolymer. The copolymer may be a copolymer resulting from polymerisation of one or more monomers comprising a vinylidene moiety, or the copolymer may be a polyurethane.

In one embodiment, the or each polymer, or at least on of the polymers, is a copolymer resulting from polymerisation of a C₂₋₁₀ alkene and a compound of formula (I):

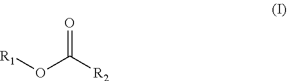

wherein R¹ is a C₂₋₁₀ alkenyl group and R² is a C₁₋₁₀ alkyl group, an aryl group or a heteroaryl group. For instance, the polymer may be a copolymer resulting from polymerisation of a C₂₋₆ alkene and a compound of formula (I) wherein R¹ is a C₂₋₆ alkenyl group and R² is a C₁₋₆ alkyl group. For instance, R¹ may be a C₂ alkenyl group whilst R² may be a methyl group, an ethyl group, a propyl group, a butyl group, a pentyl group or a hexyl group. For instance, R¹ is a C₂ alkenyl group and R² is a methyl group or an ethyl group, preferably a methyl group. Thus, the polymer may be a copolymer of ethylene and vinyl acetate (poly(ethylene-co-vinyl acetate)).

Typically, the poly(ethylene-co-vinyl acetate) comprises at least 20% by weight vinyl acetate, at least 30% by weight vinyl acetate, at least 40% by weight vinyl acetate, at least 50% by weight vinyl acetate, at least 60% by weight vinyl acetate, at least 70% by weight vinyl acetate or at least 80% by weight vinyl acetate.

Thus, typically, the polymer is selected from poly(ethylene-co-vinyl acetate), polyvinyl alcohol, polyurethane, polydimethylsiloxane (PDMS) or polyvinyl acetate.

### Metal Nanowires

The metal nanowires may comprise any conductive metal. The metal nanowires may comprise, consist essentially of or consist of an elemental metal. Alternatively, the metal nanowires may comprise, consist essentially of or consist of two or more metals. Hence, the metal nanowires may comprise, consist essentially of or consist of a conductive alloy.

Typically, the metal nanowires comprise, consist essentially of or consist of one or more of silver, gold, copper and nickel. The metal nanowires may comprise one or more of silver and gold. Preferably, the metal nanowires comprise, consist essentially of or consist of silver, which may be particularly effective in providing electrically-conductive nanowires.

The sensor material typically comprises at least 0.01 weight % nanowires, for instance at least 0.025 weight % nanowires, at least 0.05% weight nanowires, at least 0.075% weight nanowires, or at least 0.1% weight nanowires. Preferably, the sensor material comprises no more than 10 wt % nanowires, for instance no more than 7.5% weight nanowires, no more than 5% weight nanowires, no more than 2.5% weight nanowires, no more than 1% weight nanowires, no more than 0.5% weight nanowires or no more than 0.25% weight nanowires.

Typically, the sensor material comprise between 0.01 and 10% by weight nanowires, between 0.01 and 7.5% by weight nanowires, between 0.01 and 5% by weight nanowires, between 0.01 and 2.5% by weight nanowires or between 0.01 and 1% by weight nanowires, between 0.01 and 0.5% by weight nanowires or between 0.01 and 0.25% by weight nanowires. For instance, the sensor material may comprise between 0.075 and 10% by weight nanowires, between 0.075 and 7.5% by weight nanowires, between 0.075 and 5% by weight nanowires, between 0.075 and 2.5% by weight nanowires, between 0.075 and 1% by weight nanowires, between 0.075 and 0.5% by weight nanowires or between 0.075 and 0.25% by weight nanowires. The sensor material may comprise about 0.075% by weight nanowires, about 0.1% by weight nanowires, about 0.125% by weight nanowires, or about 0.15% by weight nanowires.

When the sensor material is in the form of a film, typically the film of the sensor material comprises the metal nanowires at a concentration of at least 0.05 mg/cm², at least 0.1 mg/cm², or at least 0.15 mg/cm². The film of the sensor material typically comprises the metal nanowires at a concentration of no more than 1 mg/cm².

### Force Sensor Array

The invention also provides a force sensor which comprises an array of sensor materials, as described herein, wherein each sensor material comprises a plurality of metal nanowires dispersed within a matrix; and at least one measurement device, as described herein, wherein the at least one measurement device is configured to measure an electrical property of each sensor material, wherein the electrical property is one which changes in response to the application of a force to the sensor material. Each sensor material in the array of sensor materials may be a sensor material as described herein. The electrical property may be one which changes in response to an internal stress in the sensor material caused by application of a force to the sensor material.

The force sensor typically further comprises a plurality of electrical connectors, wherein the electrical connectors form electrical connections between the sensor materials and the at least one measurement device. For instance, the sensor materials may be arranged in the form of a grid.

The force sensor typically comprises a data acquisition unit configured to acquire data from each sensor material in the array and provide a map of force across the array.

For instance, the force sensor may comprise a data acquisition unit configured to acquire data from each sensor material in the array and provide a map of compressive force across the array. For instance, the force sensor may comprise a data acquisition unit configured to acquire data from each sensor material in the array and provide a map of pressure across the array. In this way, the force sensor may be used to detect areas where a high compressive force or pressure is applied and areas where a low compressive force or pressure is applied.

Thus, the force sensor may be a pressure sensor, and the present invention also relates to a pressure sensor comprising an array of sensor materials, as described herein, wherein each sensor material comprises a plurality of metal nanowires dispersed within a matrix; and at least one measurement device, as described herein, wherein the at least one measurement device is configured to measure an electrical property of each sensor material, wherein the electrical property is one which changes in response to (an internal stress in the sensor material caused by) application of a force to the sensor material.

For instance, the force sensor may comprise a data acquisition unit configured to acquire data from each sensor material in the array and provide a map of tensile force across the array. In this embodiment, the force sensor may be mounted upon a substrate and used to detect tensile strain in the substrate. As the substrate bends or otherwise changes shape upon application of a force, the sensor materials mounted on the substrate also experience a tensile force which effects their electrical properties, typically resistance. The changes in electrical properties, typically resistance, may be monitored and used to establish whether there are particular areas of the substrate that are experiencing higher or lower levels of tensile strain. Thus, the force sensor may be a strain gauge, and the present invention also relates to a to a strain gauge comprising an array of sensor materials, as described herein, wherein each sensor material comprises a plurality of metal nanowires dispersed within a matrix; and at least one measurement device, as described herein, wherein the at least one measurement device is configured to measure an electrical property of each sensor material, wherein the electrical property is one which changes in response to (an internal stress in the sensor material caused by) application of a force to the sensor material.

The force sensors as described herein have a wide variety of applications. For instance, the force sensor may be mounted in a car seat and used to detect areas where a higher pressure is applied by the user of the car seat. In this regard, the present invention also relates to a car seat comprising any force sensor as described herein. The force sensor may be employed as an electronic skin in robotics or as a sensor incorporated into wearable electronics. Alternatively, the force sensor may be used in medical applications, for instance for health monitoring to measure pulse or blood pressure, or to detect where particular pressure is exerted on a bed by a bed-bound patient to anticipate the build up of pressure sores. The force sensor may also be used in sports equipment to monitor and improve performance.

### Method of Sensing Force

The invention also provides a method of sensing force applied to a sensor material, comprising applying a force to a sensor material, wherein the sensor material comprises a plurality of metal nanowires dispersed within a matrix; and measuring an electrical property of the sensor material, wherein the electrical property is one which changes in response to application of the force to the sensor material. Typically, the electrical property is one which changes in response to an internal stress in the sensor material caused by application of the force to the sensor material.

Measuring the electrical property may comprise measuring the change in the electrical property which occurs upon application of the force to the sensor material. The extent of the change in the electrical property is typically proportional to the amount of the force applied. The amount of force applied can thereby be sensed. Indeed, the fact that the change in the electrical property is proportional to the amount of the force applied allows for calibration of the force sensor, such that the absolute amount of force applied can be measured.

Typically, the electrical property is resistance or capacitance. The force may be any force as described herein, for instance a compressive force, a tensile force or a pressure. The sensor material may be any sensor material as described herein i.e. comprises a matrix material as described herein and metal nanowires as described herein. Typically, the sensor material is in the form of a film. The film of the sensor material may be as described herein, i.e. may have any combination of first, second and third sub-layers as described herein.

In one embodiment, the sensor material is in the form of a film, wherein the film of the sensor material comprises a first sub-layer in contact with a second sub-layer, wherein both the first sub-layer and the second sub-layer comprise a plurality of the metal nanowires dispersed within the matrix, wherein the density of the metal nanowires is greater in the first sub-layer than in the second sub-layer, wherein the method comprises applying a compressive force to the sensor material that pushes the nanowires closer together, and wherein the electrical property measured is resistance. FIG. 2A is a schematic showing a compressive force or pressure being applied to a film of a sensor material having first and second sub-layers as described herein. FIG. 2B shows how the resistance of the sensor material changes in response to the force applied.

In another embodiment, the sensor material is in the form of a film, wherein film of the sensor material comprises a first sub-layer in contact with a second sub-layer, wherein both the first sub-layer and the second sub-layer comprise a plurality of the metal nanowires dispersed within the matrix, wherein the density of the metal nanowires is greater in the first sub-layer than in the second sub-layer, wherein the method comprises applying a force to the sensor material that causes a tensile stress within the sensor material that pulls the nanowires apart, and wherein the electrical property measured is resistance. FIG. 3A is a schematic showing a tensile force being applied to a film of a sensor material having first and second sub-layers as described herein. FIG. 3B shows how the resistance of the sensor material changes in response to the force applied.

In another embodiment, the sensor material is in the form of a film, wherein film of the sensor material comprises a first sub-layer, a second sub-layer and a third sub-layer, wherein the first and third sub-layers are in contact with the second sub-layer, such that the second sub-layer is disposed between the first and third sub-layers, and wherein each of the first, second and third sub-layers comprises a plurality of the metal nanowires dispersed within the matrix, wherein the density of the metal nanowires is greater in the first and third sub-layers than in the second sub-layer, wherein the method comprises applying a compressive force to the sensor material that pushes the first and third sub-layers closer together, and wherein the electrical property measured is capacitance. FIG. 4A is a schematic showing a compressive force or pressure being applied to a film of a sensor material having first, second and third sub-layers as described herein. FIG. 4B shows how the capacitance of the sensor material changes in response to the force applied.

### Use of the Sensor Material

The invention also relates to the use of an material which comprises a plurality of metal nanowires dispersed within a matrix to sense force applied to the material. The material may be any sensor material as described herein, i.e. a material that comprises a matrix material as described herein and metal nanowires as described herein. The use of the material to sense force, and the force that is sensed, may both be as further defined herein.

### Material

The present invention also provides a film of an material comprising a plurality of metal nanowires dispersed within a matrix material, wherein the distribution of the metal nanowires throughout the thickness of the film is non-uniform.

The matrix and the metal nanowires may be as further described herein. The film of the material may be as further described herein; e.g. it may have any combination of first, second and third sub-layers as described herein.

Thus, the film of the material may comprise a first sub-layer in contact with a second sub-layer, wherein both the first sub-layer and the second sub-layer comprise a plurality of the metal nanowires dispersed within the matrix, wherein the density of the metal nanowires is greater in the first sub-layer than in the second sub-layer. Typically, the density of the metal nanowires in the first sub-layer is more than twice the density of metal nanowires in the second sub-layer.

Typically, the first sub-layer is 10 to 90% of the thickness of the film and the second sub-layer is from 10 to 90% of the thickness of the film, for instance the first sub-layer may be 25 to 75% of the thickness of the film and the second sub-layer may be from 25 to 75% of the thickness of the film, or the first sub-layer may be 40 to 60% of the thickness of the film and the second sub-layer may be from 40 to 60% of the thickness of the film.

In one embodiment, the film of the material comprises a third sub-layer in contact with the second sub layer, such that the second sub-layer is disposed between the first and third sub-layers. Typically, the density of the metal nanowires is greater in the third sub-layer than in the second sub-layer. For instance, the density of the metal nanowires in the third sub-layer may be more than twice the density of metal nanowires in the second sub-layer.

The present invention also provides a material comprising a plurality of metal nanowires dispersed within a matrix material, wherein the matrix material comprises a copolymer of ethylene and vinyl acetate (ethylene-co-vinyl acetate).

### Method of Manufacturing Sensor Material

The sensor material may be manufactured using a method comprising depositing one or more solutions comprising the metal nanowires and the matrix material on a substrate. In this context, it should be understood that the term “solutions” embraces dispersions formed with non-soluble components, such as the metal nanowires.

For instance, the method may comprise depositing two solutions, one comprising the metal nanowires and the other comprising the matrix material on a substrate. The method may comprise depositing one solution that comprises both the metal nanowires and the matrix material on a substrate.

Typically, the method comprises depositing a first solution comprising the metal nanowires on a substrate, then depositing a second solution comprising the matrix material on the metal nanowire solution-treated substrate. Typically, the first solution comprises a first solvent and the metal nanowires. The first solvent may be any suitable solvent known to the skilled person, for instance a polar solvent, typically a polar protic solvent. Hence, the first solvent may be selected from a volatile alcohol, water or mixtures thereof. Typically the first solvent is a C1-C4 alcohol (for example methanol, ethanol, propanol or butanol) or water, or mixtures thereof. The concentration of metal nanowires in the first solvent is typically 0.1 to 10 mg/ml, preferably from 1.0 to 4.0 mg/mL.

The second solution typically comprises the matrix material and a second solvent. The second solvent is typically an aprotic solvent. For instance, the second solvent may be an apolar aprotic solvent such as toluene or chloroform. The concentration of matrix material in the second solution is typically between 1 and 30 weight percent, typically between 5 and 25 weight percent, or between 7 and 14 weight percent.

The steps of depositing the first or second solution may be performed using drop casting, spin coating or printing.

The method typically includes one or more drying steps. For instance, after depositing the first solution on the substrate, the solution-treated substrate is typically dried before the second solution is deposited. Typically, the method comprises a step of drying the substrate after treatment with the second solution. Drying may be in air at room temperature, or at an elevated temperature, for instance between 30 and 100° C., typically between 50 and 100° C., for instance about 60° C., about 70° C., about 80° C. or about 90° C.

Typically, the sensor material is produced in the form of a film. The film may be removed from the substrate, or may be left on the a substrate. For instance, the sensor material may be formed on a substrate as part of a strain gauge to measure strain within the substrate.

Two films may be bonded together to form a sensor material having first, second and third sub-layers as described herein. Alternatively, a further layer of metal nanowires may be disposed on the layer of matrix material to form a sensor material having first, second and third sub-layers as described herein.

The method for manufacturing a force sensor of the present invention may further comprise electrically connecting a sensor material as described herein to a measurement device as described herein. Typically, the sensor material is connected to the measurement device by a first electrical connector and a second electrical connector, wherein the first and second electrical connectors form an electrical connection between the sensor material and the measurement device.

### EXAMPLES

### Example 1—Film Fabrication Process

A film of a sensor material is manufactured as follows:
Prepare silver nanowire solution by dispersing the nanowires in a polar solvent (typically methanol or any volatile alcohols, or water). The concentration of nanowires can be set between 1.0 to 4.0 mg/ml.
Deposit silver nanowires on a glass slide. The shape and size of glass slide can be varied and is used to determine the final dimensions of the film. For instance, the area may be 1.5×1.5 cm², 2.5×2.5 cm², 5×5 cm² or 10×10 cm².

Several deposition methods can be used: drop casting, spin coating or printing. Drop casting and printing are preferred as thicker conductive films can be produced. Typical concentration of nanowire on glass should be greater than 0.16 mg/cm². Films with lower concentrations typically result in lower conductivity films which makes measuring their electrical response more difficult.
Allow film to dry. Slight heat can be applied (around 80° C.) if water is used as solvent.
Prepare poly(ethylene-co-vinyl acetate) (EVA) solution by dissolving EVA in toluene. The concentration of the EVA in the EVA-toluene solution is typically set to between 7 to 14 percent by weight based on the total weight of solvent and EVA.
After silver nanowire has dried, deposit EVA solution onto the silver nanowires. The EVA solution can be deposited using drop casting or printing. The overall thickness of the film can be controlled by the amount and concentration of EVA solution deposited. The EVA will flow into the gaps between the silver nanowire network on the glass, forming a composite film structure.
Allow EVA solution to dry completely.
After the film has dried, the nanowire-EVA film can be easily peeled off the glass slide. The side in contact with the glass will be the conductive side (shown as a black line in the Figures) as most of the nanowires are present there. Film thickness is typically below 4 mm.

Note: These procedures will work if nanowires are used. Nanoparticles cannot be used as they are more difficult to embed into the EVA matrix. Nanoparticles will remain on the glass rather than be pulled up by the EVA.

An SEM image of film of the silver nanowires used is shown in FIG. 5. An SEM image of the silver nanowires in the EVA polymer matrix made by the above method is shown in FIG. 8.

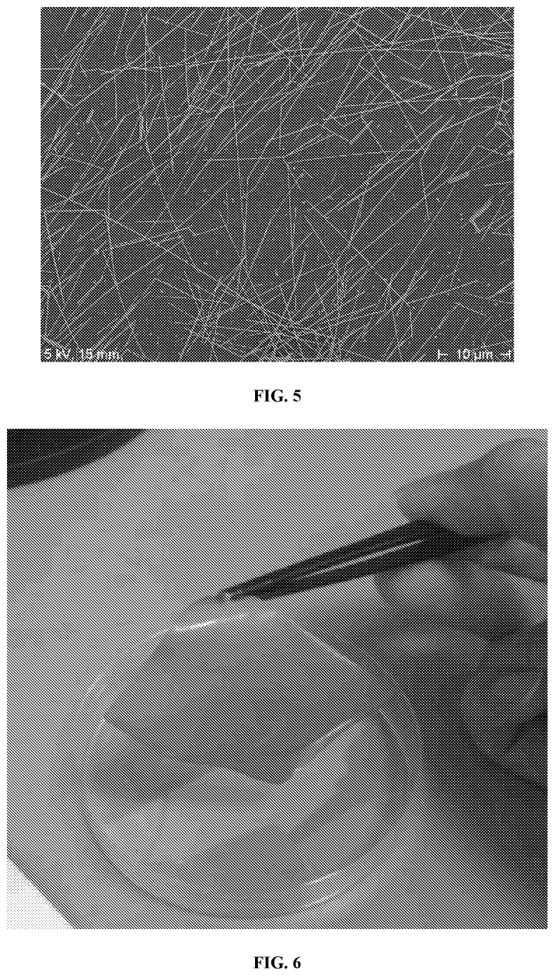

FIG. 6 is a photograph of a film of silver nanowires in an EVA film made by the method of this example.

### Example 2—Characterizing Electrical Properties Under Stress

Equipment: Agilent E4980A Precision LCR Meter (can measure both resistance and capacitance). Kiethley 2400 source meter can also be used for measuring resistance.

### Measurement of Compressive Stress/Resistance (See FIG. 2):

Attach two strips of copper tape to two opposite corners of the film.
Place film on a non-conductive surface.
Connect the ends of each copper tape to the measurement device using wires and clips.
Place small loads, ranging from 5 to 80 g on the film and record the corresponding value of resistance.

### Measurement of Tensile Stress/Resistance (See FIG. 3):

Attach two strips of copper tape to two opposite corners of the film.
Place the two corners of film onto two separated supporting surfaces, with the conductive side (black line in FIG. 3A) facing down.
Connect the ends of each copper tape to the measurement device using wires and clips.
Place small loads, ranging from 5 to 80 g on the film and record the corresponding value of resistance.

### Measurement of Compressive Stress/Capacitance (See FIG. 4):

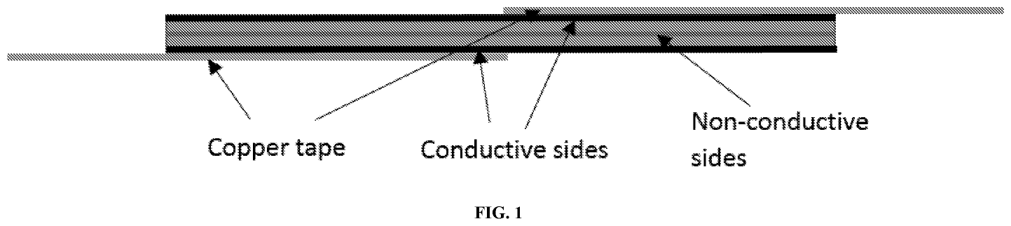

Stack two pieces of films together with the conductive sides (black lines in FIG. 4A) facing away from each other.
Attach a strip of copper tape to the center of each of the conductive faces (see FIG. 1).
Place films onto a non-conductive surface.
Connect the ends of each copper tape to the measurement device using wires and clips.
Place small loads, ranging from 5 to 80 g on the film and record the corresponding value of capacitance.

1. A force sensor which comprises a sensor material which comprises a plurality of metal nanowires dispersed within a matrix; and a measurement device configured to measure an electrical property of the sensor material, wherein the electrical property is one which changes in response to application of a force to the sensor material.

2. A force sensor according to claim 1 wherein the electrical property is one which changes in response to an internal stress in the sensor material caused by application of a force to the sensor material.

3. The force sensor according to claim 1 or 2 wherein the electrical property is resistance or capacitance.

4. The force sensor according to any one of claims 1 to 3 wherein the electrical property is resistance and the force is a compressive force.

5. The force sensor according to any one of claims 2 to 4 wherein the electrical property is resistance and the internal stress in the sensor material is tensile stress caused by application of the force to the sensor material.

6. The force sensor according to any one of the preceding claims wherein the electrical property is capacitance and the force is a compressive force.

7. The force sensor according to any one of the preceding claims wherein the sensor material is not transparent.

8. The force sensor according to any preceding claim further comprising a first electrical connector and a second electrical connector, wherein the first and second electrical connectors form an electrical connection between the sensor material and the measurement device, optionally wherein the first and second electrical connectors are connected to two opposing regions of the sensor material.

9. The force sensor according to any one of the preceding claims wherein the sensor material is in the form of a film.

10. The force sensor according to claim 9 wherein the distribution of the metal nanowires throughout the thickness of the film is non-uniform.

11. The force sensor according to claims 9 or 10 wherein film of the sensor material comprises a first sub-layer in contact with a second sub-layer, wherein both the first sub-layer and the second sub-layer comprise a plurality of the metal nanowires dispersed within the matrix, wherein the density of the metal nanowires is greater in the first sub-layer than in the second sub-layer.

12. The force sensor according to claim 11 wherein the density of the metal nanowires in the first sub-layer is more than twice the density of metal nanowires in the second sub-layer.

13. The force sensor according to claim 11 or claim 12 wherein the first sub-layer is 10 to 90% of the thickness of the film and the second sub-layer is from 10 to 90% of the thickness of the film, optionally wherein the first sub-layer is 25 to 75% of the thickness of the film and the second sub-layer is from 25 to 75% of the thickness of the film, optionally wherein the first sub-layer is 40 to 60% of the thickness of the film and the second sub-layer is from 40 to 60% of the thickness of the film.

14. The force sensor according to any preceding claim wherein the electrical property is resistance.

15. The force sensor according to any one of claims 9 to 14 wherein the force applied to the sensor material is a compressive force that pushes the nanowires closer together, and wherein the electrical property measured is resistance.

16. The force sensor according to any one of claims 9 to 14 wherein the force applied to the sensor material is a force that causes a tensile stress within the sensor material that pulls the nanowires apart, and wherein the electrical property measured is resistance.

17. The force sensor according to claim 11 or claim 12 wherein the film of the sensor material comprises a third sub-layer in contact with the second sub layer, such that the second sub-layer is disposed between the first and third sub-layers.

18. The force sensor according to claim 17 wherein the density of the metal nanowires is greater in the third sub-layer than in the second sub-layer.

19. The force sensor according to claim 18 wherein the density of the metal nanowires in the third sub-layer is more than twice the density of metal nanowires in the second sub-layer.

20. The force sensor according to any one of claims 1 to 13 and 17 to 19 wherein the electrical property is capacitance.

21. The force sensor according to any one of claims 17 to 20 wherein the force applied to the sensor material is a compressive force that pushes the first and third sub-layers closer together, and wherein the electrical property measured is capacitance.

22. The force sensor according to any one of claims 9 to 21 further comprising a solid substrate, wherein the film of sensor material is disposed on the solid substrate.

23. The force sensor according to any one of claims 9 to 14 and 16 further comprising a support, wherein the film of sensor material is supported at two or more edges by the support.

24. The force sensor according to any one of claims 9 to 23 further comprising a first electrical connector and a second electrical connector, wherein the first and second electrical connectors form an electrical connection between the sensor material and the measurement device, wherein the first and second electrical connectors are attached to opposing edges or corners of the film of the sensor material.

25. The force sensor according to any one of claims 9 to 23 further comprising a first electrical connector and a second electrical connector, wherein the first and second electrical connectors form an electrical connection between the sensor material and the measurement device, wherein the first and second electrical connectors are attached to opposing faces of the film of the sensor material.

26. The force sensor according to any one of the preceding claims wherein the matrix comprises a polymer, preferably wherein the polymer is an elastic polymer.

27. The force sensor according to claim 26 wherein the polymer has a glass transition temperature (T_{g}) of below 0° C., preferably below −10° C., more preferably below −20° C.

28. The force sensor according to claim 26 or claim 27 wherein the polymer is an insulator.

29. The force sensor according to any one of claims 26 to 28 wherein the polymer results from polymerisation of one or more monomers comprising a vinylidene moiety.

30. The force sensor according to any one of claims 26 to 29 wherein the polymer is a copolymer.

31. The force sensor according to claim 30 wherein the polymer is a copolymer resulting from polymerisation of a C₂₋₁₀ alkene and a compound of formula (I): 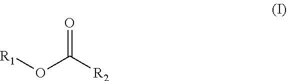
Wherein R¹ is a C₁₋₁₀ alkenyl group and R² is a C₁₋₁₀ alkyl group, an aryl group or a heteroaryl group; more preferably wherein the polymer is a copolymer resulting from polymerisation of a C₂₋₆ alkene and a compound of formula (I) wherein R¹ is a C₂₋₆ alkenyl group and R² is a C₁₋₆ alkyl group.

32. The force sensor according to any one of claims 26 to 31 wherein the polymer is selected from a copolymer of ethylene and vinyl acetate (poly(ethylene-co-vinyl acetate)), polyvinyl alcohol, polyurethane, polydimethylsiloxane (PDMS) or polyvinyl acetate.

33. The force sensor according to any one of the preceding claims wherein the metal nanowires comprise one or more of silver, gold, copper and nickel.

34. The force sensor according to claim 33 wherein the metal nanowires are silver nanowires.

35. The force sensor according to any one of the preceding claims wherein the sensor material comprises at least 0.01 weight % nanowires, and preferably no more than 10 wt % nanowires.

36. A force sensor which comprises an array of sensor materials, wherein each sensor material comprises a plurality of metal nanowires dispersed within a matrix; and at least one measurement device, wherein the at least one measurement device is configured to measure an electrical property of each sensor material, wherein the electrical property is one which changes in response to application of a force to the sensor material.

37. A force sensor according to claim 36 wherein the electrical property is one which changes in response to an internal stress in the sensor material caused by application of a force to the sensor material.

38. The force sensor according to claim 36 or 37 further comprising a data acquisition unit configured to acquire data from each sensor material in the array and provide a map of force across the array.

39. The force sensor according to claim 36, 37 or 38 wherein each sensor material and/or electrical property is as defined in any one of claims 2 to 7, 9 to 21 and 26 to 35.

40. The force sensor according to any one of claims 36 to 39 further comprising a plurality of electrical connectors, wherein the electrical connectors form electrical connections between the sensor materials and the at least one measurement device.

41. A method of sensing force applied to a sensor material, comprising applying a force to a sensor material, wherein the sensor material comprises a plurality of metal nanowires dispersed within a matrix; and measuring an electrical property of the sensor material, wherein the electrical property is one which changes in response to application of the force to the sensor material.

42. A method according to claim 41 wherein the electrical property is one which changes in response to an internal stress in the sensor material caused by application of the force to the sensor material.

43. A method of sensing force according to claim 41 or 42 wherein the electrical property is resistance or capacitance.

44. A method of sensing force according to claim 41, 42 or 43 wherein the sensor material and/or electrical property is as defined in any one of claims 2 to 7, 9 to 21 and 26 to 35.

45. A method of sensing force according to any one of claims 41 to 44 wherein the sensor material is in the form of a film, wherein the film of the sensor material comprises a first sub-layer in contact with a second sub-layer, wherein both the first sub-layer and the second sub-layer comprise a plurality of the metal nanowires dispersed within the matrix, wherein the density of the metal nanowires is greater in the first sub-layer than in the second sub-layer, wherein the method comprises applying a compressive force to the sensor material that pushes the nanowires closer together, and wherein the electrical property measured is resistance.

46. A method of sensing force according to any one of claims 41 to 44 wherein the sensor material is in the form of a film, wherein the film of the sensor material comprises a first sub-layer in contact with a second sub-layer, wherein both the first sub-layer and the second sub-layer comprise a plurality of the metal nanowires dispersed within the matrix, wherein the density of the metal nanowires is greater in the first sub-layer than in the second sub-layer, wherein the method comprises applying a force to the sensor material that causes a tensile stress within the sensor material that pulls the nanowires apart, and wherein the electrical property measured is resistance.

47. A method of sensing force according to any one of claims 41 to 44 wherein the sensor material is in the form of a film, wherein the film of the sensor material comprises a first sub-layer, a second sub-layer and a third sub-layer, wherein the first and third sub-layers are in contact with the second sub-layer, such that the second sub-layer is disposed between the first and third sub-layers, and wherein each of the first, second and third sub-layers comprises a plurality of the metal nanowires dispersed within the matrix, wherein the density of the metal nanowires is greater in the first and third sub-layers than in the second sub-layer, wherein the method comprises applying a compressive force to the sensor material that pushes the first and third sub-layers closer together, and wherein the electrical property measured is capacitance.

48. Use of a material which comprises a plurality of metal nanowires dispersed within a matrix to sense force applied to the material.

49. Use according to claim 48 wherein the material is a sensor material as defined in any one of claims 2 to 7, 9 to 21 and 26 to 35.

50. A film of an material comprising a plurality of metal nanowires dispersed within a matrix material, wherein the distribution of the metal nanowires throughout the thickness of the film is non-uniform.

51. A film of an material according to claim 50 wherein the film has a structure as defined in any one of claims 11 to 13 and 17 to 19.

52. A film of an material according to claim 50 or claim 51 wherein the matrix is as defined in any one of claims 26 to 32 and the metal nanowires are as defined in any one of claims 33 to 35.

53. A material comprising a plurality of metal nanowires dispersed within a matrix material, wherein the matrix material comprises a copolymer of ethylene and vinyl acetate (poly(ethylene-co-vinyl acetate)).
